(19) United States
(12) Patent Application Publication
(10) Pub. No.: US 2016/0292783 A1
(43) Pub. Date: Oct. 6, 2016

(54) ONLINE MARKETPLACE INTERFACE HAVING A NETWORK OF QUALIFIED USER OFFERS

(71) Applicant: PAYPAL, INC., San Jose, CA (US)

(72) Inventor: Rahul Nair, Austin, TX (US)

(21) Appl. No.: 14/675,612

(22) Filed: Mar. 31, 2015

(51) Int. Cl. G06Q 40/02

(52) U.S. Cl. CPC G06Q 40/025

(57) ABSTRACT

There are provided systems and methods for an online marketplace having a network of qualified user offers. A service provider may offer an online marketplace to connect lenders and borrowers. A lender may establish a financial offer with the online marketplace by entering at least an amount that the lender wishes to provide to a borrower to the online marketplace. The lender may also establish terms for acceptance of the financial offer, including required collateral, which may take the form of a virtual asset of the borrower. The borrower may access the online marketplace to search and browse financial offers. Once the borrower finds and/or negotiates an acceptable offer, the borrower may receive the amount for the offer after completing the terms of acceptance, including providing the virtual asset to the lender. The lender may then prevent access and/or use of the virtual asset in the event of default.

### TECHNICAL FIELD

The present application generally relates to online marketplace interfaces and more specifically to an online marketplace interface having a network of qualified user offers.

### BACKGROUND

Borrowers may wish to borrow finances from one or more lenders in order to pay for items, obtain credit for future user, and/or refinance a previous loan. Borrowers may utilize financial institutions, such as banks, credit companies, or other types of large scale borrowers to obtain such funds. However, such financial institutions often provide nonnegotiable terms to loans or other types of financial offers, and determination of an amount, interest rate, loan fee, and/or repayment structure is up to the financial institution based on a credit history of the borrower. Thus, many borrowers may accept sub-optimal loans or may not be able to receive a financial offer meeting the borrower's needs. A borrower may choose to use a smaller scale lender, including a personal lender, but many issues in predatory lending, repayment, or other complexity may prevent borrowers from acceptance of such loans.

### BRIEF DESCRIPTION OF THE DRAWINGS

FIG. 1 is a block diagram of a networked system suitable for implementing the processes described herein, according to an embodiment;

FIG. 2 is two exemplary browser webpages having borrower and lender interfaces for an online lending marketplace, according to an embodiment;

FIG. 3 is an exemplary system environment having communication devices executing browser modules for a lending marketplace interface and a server executing a lending marketplace module to provide one or more financial offers from a lender to a borrower, according to an embodiment;

FIG. 4 is a flowchart of an exemplary process for an online marketplace interface having a network of qualified user offers, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide an online marketplace interface having a network of qualified user offers. Systems suitable for practicing methods of the present disclosure are also provided.

A service provider server, such as server for a merchant, a marketplace, a payment provider, or other type of service provider, may host an online lending and financial marketplace, where one or more users (e.g., borrowers) may visit to view lending and other financial offers from other users (e.g., creditors, lenders, etc.). The service provider may establish a lending marketplace interface for the online marketplace, accessible and retrievable over a network using a web browser or a dedicated application of the service provider. The users may utilize a communication device to access the lending marketplace interface and engage in lending transactions with other users. The online lending marketplace may be established to provide peer-to-peer lending, including lending by individual lenders (e.g., single users) and/or groups of individual lenders. The lenders may establish financial offers based on an amount of money the lender is willing to lend, terms the lender would like to set, risk tolerance of the lenders, collateral the lender is willing to accept, and/or other lending factors, including acceptability of various repayment methods.

The lenders may also allow for negotiation of one or more terms of the financial offer, including an amount, interest rate, collateral, repayment structures, and seizure of assets and/or collateral in the event of non-payment. Utilizing the lending marketplace interface displayed to one or more lenders on one or more output displays of one or more a communication devices, the lender(s) may establish a plurality of financial offers, for example, through a lender portal/interface. The financial offers may have the aforementioned terms as determined by the lender(s). The lending marketplace interface may provide for entry of the teiins through elements accepting character entry, dropdown menus, selectable options, or other types of data entry. Collateral acceptable to the lender may include real and/or virtual assets. For example, real assets may include car and/or house titles or liens and other types of property (e.g., jewelry, furniture, etc.). Virtual assets may include online, electronic, or other representation of value or currency in a virtual environment. The “value” may not be traditional money or currency (real or virtual) related, but instead may be value to a specific user. For example, the virtual asset can be access to a user's account for social networking site or a public review site, where denying a user of using the account to post may be much more valuable to one user than another user. Thus, a virtual asset may correspond to (or access to) one or more of a social networking account, a media sharing account, a messaging account, an email account, an online banking account, a video game account, a video game currency, and a video game item or obtainable asset. The lender(s) may require the virtual asset as collateral so that access credentials or other control over the virtual asset may be provided to the online lending marketplace and/or the lender(s) for access, control, and/or possession in the event of default. In various embodiments, the lender(s) may accept payment in the form of the virtual asset, for example, video game assets and/or currency.

Once the lender(s) have completed entry of information for a financial offer, the lending marketplace interface may communicate the amount for the financial offer, terms for the financial offer, and a financial asset used for disbursement of the financial offer (e.g., a monetary transfer, credit card authorization, bank account withdrawal authorization, or other payment of the amount to the online lending marketplace). The online lending marketplace may hold the amount in escrow for later disbursement of the amount on acceptance of the financial offer by a borrower. In other embodiments, the online lending marketplace may only require payment of the amount by the lender(s) on acceptance of the financial offer by the borrower. Moreover, if the financial offer expires (either on a time/term set by the lender(s) or on a time/term set by the online lending marketplace to post and offer for lending the financial offer), the amount of the financial offer may be returned to the lender(s) (potentially less any fee of cost associated with posting of the financial offer by the online lending marketplace to the lender(s), which may be accrued only when the financial offer is not accepted, in various embodiments).

Once the online lending marketplace receives the information for the financial offer, the online lending marketplace may generate a posting for the financial offer. The online lending marketplace may include a plurality of financial offers established in a similar manner. One or more borrowers (e.g., single users or small groups of users, including friends, co-workers, colleagues, families, and classmates) may access the online lending marketplace utilizing a communication device over a network. The borrower may utilize a web browser to access a website for the service provider server (e.g., the marketplace server) or may utilize a dedicated application for the service provider/marketplace, which may access the online lending marketplace. The communication device may receive the lending marketplace interface for display through an output display of the communication device, which may include a borrower portal/interface allowing the borrower to find one or more financial offers matching the borrower's interests. The borrower may peruse the plurality of financial offers, such as through webpages, listings, or other viewable elements. The lending marketplace interface may further include searchable elements, including search boxes utilized with search terms, dropdown menus allowing for entry of amount, terms, or other information, and/or selectable boxes. The borrower may generate a search for a specific financial offer of the plurality of financial offers meeting the borrower's interests using such elements. In various embodiments, the online lending marketplace may include past searches, user information, or other information particular to the borrower, which may be utilized to provide smart searching and/or targeted advertisement of one or more financial offers.

The online lending marketplace may receive the search request and may respond to the user through the lending marketplace interface with one or more financial offers. The borrower may view information for the financial offer, including amount, interest, fees, repayment structures, required collateral, asset seizure in the event of non-payment, and/or negotiability of the financial offer. The borrower may choose to decline a presented financial offer, in which case the online lending marketplace may provide another financial offer. In various embodiments, the online lending marketplace may show multiple financial offers, including pagination to multiple webpages having the financial offers. In such embodiments, the online lending marketplace may allow for the user to browse through the financial offers and select a financial offer with terms that the user desires.

If the borrower chooses to negotiate the financial offer, the borrower may enter negotiation terms, which may be communicated to the lender(s) for acceptance and/or renegotiation. One or more rounds of asynchronous negotiations may occur in such a manner until the financial offer is acceptable to both the lender(s) and borrower or the lender(s)/borrower has rejected the financial offer. Additionally, the lender may view a risk score of the borrower and either adjust or revoke the financial offer from the borrower if the borrower does not meet the lender's risk tolerance, or require heightened terms for the financial offer. In various embodiments, the risk tolerance of the lender may be set in the financial offer to only accept borrowers below a certain risk threshold and/or require the heightened terms.

Once the borrower is ready to accept the financial offer, either after negotiation or after an initial view of the financial offer, the borrower may provide the collateral in the event collateral is required. Where the collateral corresponds to a virtual asset, the online lending marketplace and/or lender(s) may either receive access credentials for the virtual asset or receive the virtual asset to hold in escrow. The online lending marketplace may provide the lender(s) the virtual asset on default and/or the lender(s) may take control and/or possession of the virtual asset on default. In certain embodiments, the virtual assert as collateral may be required to be a certain value, which may correspond to a value to the borrower specifically instead of a general value attached to the type of collateral. For example, the virtual asset may correspond to a social networking account used often by the borrower, and thus have a higher value to the borrower. The virtual asset may also correspond to a social networking and/or media sharing account followed by many users, thus, advertisement revenue from the virtual asset may be more than for an account followed by few users. In such embodiments, the virtual asset may be worth more and thus serve to fulfill a higher amount of the required amount for the collateral.

Once acceptance is completed, the online lending marketplace may dispense the amount to the borrower. The online lending may track repayment of the financial offer by the borrower. A risk score for the borrower may be adjusted based on the borrower's repayment information, including on-time, early, and/or later repayment. In the event of default, the online lending marketplace may release the collateral to the lender and/or take possession of one or more assets of the borrower, including virtual assets, to effectuate repayment.

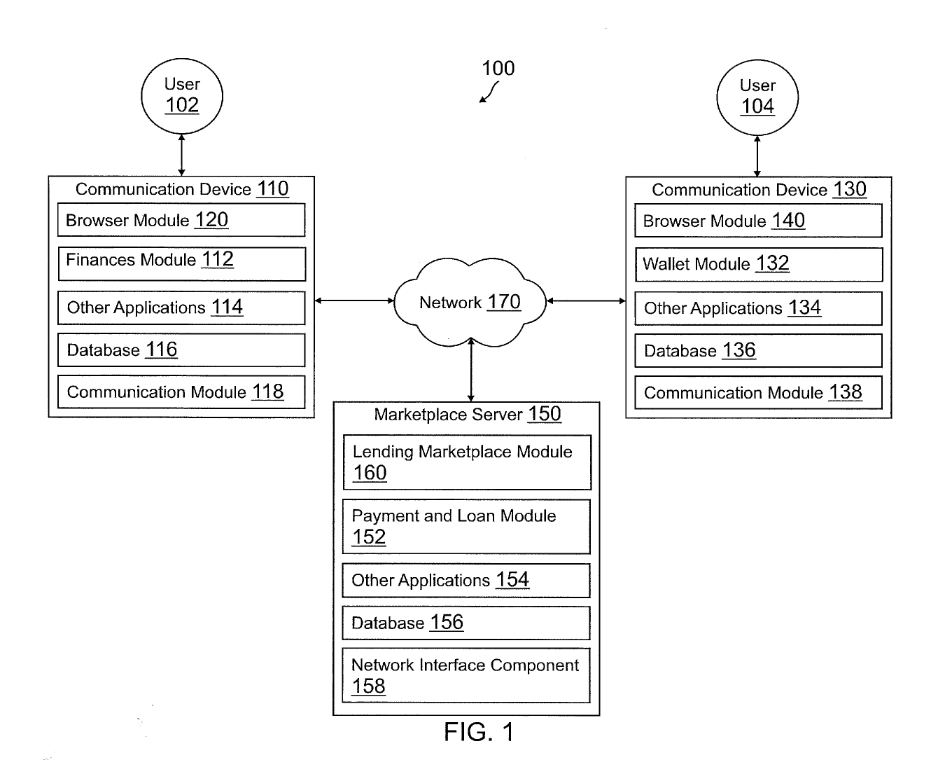

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102 (e.g., a lending user), a user 104 (e.g., a borrowing user), a communication device 110, a communication device 130, and a marketplace server 150 in communication over a network 170. User 102, the lender, may establish one or more financial offers with an online lending marketplace offered by marketplace server 150, including credit, loan, and/or refinancing offers. Marketplace server 150 may host an online lending marketplace including the financial offer(s) from user 102 and/or other users. User 104, the borrower, may access the online lending marketplace using communication device 130, where user 104 may search the online lending marketplace for one or more financial offers meeting the interests of user 104. Marketplace server 150 may then function as an intermediary to negotiate and/or process a lending transaction between user 102 and user 104 through communication device 110 and communication device 130, respectively.

Communication device 110, communication device 130, and marketplace server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Communication device 110 may be implemented using any appropriate hardware and software configured for wired and/or wireless communication with communication device 130 and/or marketplace server 150, for example, over network 170. For example, in one embodiment, communication device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly, for example, in possession by one or more lenders, which may correspond to the same or different financial offer.

Communication device 110 of FIG. 1 contains a browser module 120, finances module 112, other applications 114, a database 116, and a communication module 118. Browser module 120, finances module 112, and other applications 114 may correspond to executable processes, procedures, and/or applications with associated hardware. In other embodiments, communication device 110 may include additional or different software as required.

Browser module 120 may correspond to one or more processes to execute modules and associated devices of communication device 110 to provide a web browser, which may send and receive information over network 170, including retrieving website information (e.g., webpages and webpage data, such as interfaces and elements for accepting input) and communicating information to a website. In this regard, browser module 120 may correspond to specialized hardware and/or software utilized by communication device 110 to access a website corresponding to marketplace server 150 or retrieve other server information for an online lending marketplace hosted by marketplace server 150, as discussed herein. Browser module 120 may receive a lending marketplace interface for use of the online lending marketplace by user 102. The lending marketplace interface may allow for user 102 to generate, establish, and maintain one or more financial offers (e.g., an offer of a loan, credit, and/or refinancing), which may utilize one or more other lenders, in various embodiments. In various embodiments, browser module 120 may include a general browser application configured to retrieve, present, and communication information over the Internet (e.g., utilize resource on the World Wide Web) or a private network. However, in other embodiments, browser module 120 may include a dedicated application of marketplace module 150 or other entity, which may be configured to send and receive data over the Internet or private network using one or more application interfaces (e.g., interfaces specifically designed for the application and displayable using the application software).

Thus, browser module 120 may display the lending marketplace interface to user 102 through one or more output displays of communication device 110, which may include visual, audio, and/or audiovisual displays. User 102 may utilize the lending marketplace interface to communicate information to marketplace server 150 allowing for establishment of a financial offer in accordance with user 102's offer interests and guidelines. Such information may include an amount for the financial offer, an interest rate and origination, closing, or maintenance fees of the financial offer, a repayment structure of the financial offer, required collateral for disbursement of the financial offer (including acceptance of real or virtual assets, a value of the collateral, and a value of various virtual assets to user 102 and/or user 104). The information may include a risk tolerance for user 102, which may affect acceptability of the offer by one or more borrowers. In various embodiments, the risk tolerance may be variable based on the interest rate accepted by the borrower, the fees for the financial offer paid by the borrower, the collateral required to be put up by the buyer, or other adjustable value by user 102. The information may further include payment information allowing for acceptance of the amount of the financial offer and escrow services of such an amount by marketplace server 150 and receipt of repayment amounts from the borrower. Once the information is communicated to marketplace server 150, user 102 may be alerted of acceptance and/or posting of the financial offer through browser module 120. Browser module 120 may further display notifications through the lending marketplace interface related to negotiation and/or acceptance of the financial offer by a borrower. The notifications may allow for user 102 to negotiate the financial offer with user 104, which may occur asynchronously so that negotiable terms may be communicated back and forth between user 102 and user 104. Once the financial offer is accepted, browser module 120 may be utilized to access the lending marketplace interface and view disbursement of the amount of the financial offer. The lending marketplace interface may also be utilized to review repayment and take control or possession over collateral in the event of default. However, in other embodiments, user 102 may receive notifications and engage in negotiation, review disbursement and repayment, and collect collateral in the event of default using another application, including a messaging application.

Finances module 112 may correspond to one or more processes to execute modules and associated specialized hardware of communication device 110 to provide payment for an amount of a financial offer to marketplace server 150. In this regard, finances module 112 fray correspond to specialized hardware and/or software utilized to provide a convenient interface to permit user 102 to select payment options and provide payment for the amount of the financial offer to marketplace server 150, which may disburse the amount to user 104 and/or hold the amount in escrow for acceptance of the financial offer. For example, finances module 112 may be implemented as a user interface enabling user 102 to enter payment options for storage by communication device 110, provide those payment options on completion of a financial offer or acceptance of the financial offer, and complete a payment to marketplace server 150. In some embodiments, finances module 112 may correspond more generally to a web browser (e.g., browser module 120) configured to view information available over the Internet or access a website corresponding to a payment service provider. Finances module 112 may utilize user financial information, such as a credit card, bank account, or other financial account, as a payment instrument when providing payment information to marketplace server 150. Additionally, finances module 112 may utilize a user account with payment provider for payment.

In various embodiments, one or more features of browser module 120 and/or finances module 112 may be incorporated in the same application so as to provide their respective features in one application.

Communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over a network, or other types of applications. Other applications 114 may also include email, texting, voice and IM applications that allow a user to send and receive emails, calls, texts, and other notifications through a network, including notifications related to a financial offer (e.g., negotiable terms, acceptance of an offer, repayment, and/or default). In various embodiments, other applications 114 may include financial applications, such as banking, online payments, money transfer, or other applications associated with a payment provider. Other applications 114 may include social networking, media sharing, banking, video game, and other applications, which may also be used in conjunction with finances module 112 and/or browser module 120, for example, to access and/or collect virtual assets provided as collateral in the event of a default. Other applications 114 may contain software programs, executable by a processor, including a graphical user interface (GUI) configured to provide an interface to the user.

Communication device 110 may further include database 116 which may include, for example, identifiers such as operating system registry entries, cookies associated with browser module 120, finances module 112, and/or other applications 114, identifiers associated with hardware of communication device 110, or other appropriate identifiers, such as identifiers used for payment/user/device authentication or identification. Identifiers in database 116 may be used by marketplace server 150 to associate communication device 110 with a particular account maintained by marketplace server 150. Database 116 may include communication device tokens and/or encryption keys, including key(s) for marketplace server 150. Database 116 may include received and communicated information, which may be utilized to establish a financial offer, negotiate terms of a financial offer, complete acceptance of a financial offer, review repayment of a repayment amount of the financial offer, and/or collect collateral in the event of default by a borrower.

Communication device 110 includes at least one communication module 118 adapted to communicate with communication device 130 and/or marketplace server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Communication device 130 may be implemented using any appropriate hardware and software configured for wired and/or wireless communication with communication device 110 and/or marketplace server 150, for example, over network 170. For example, in one embodiment, communication device 130 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLES. Although a communication device is shown, the communication device may be managed or controlled by any suitable processing device. Although only one communication device is shown, a plurality of communication devices may function similarly, for example, in possession by one or more borrowers, which may correspond to the same or different financial offer.

Communication device 130 of FIG. 1 contains a browser module 140, wallet module 132, other applications 134, a database 136, and a communication module 138. Browser module 140, wallet module 132, and other applications 134 may correspond to executable processes, procedures, and/or applications with associated hardware. In other embodiments, communication device 130 may include additional or different software as required.

Browser module 140 may correspond to one or more processes to execute modules and associated devices of communication device 130 to provide a web browser, which may send and receive information over network 170, including retrieving website information (e.g., webpages and webpage data, such as interfaces and elements for accepting input) and communicating information to a website. In this regard, browser module 140 may correspond to specialized hardware and/or software utilized by communication device 130 to access a website corresponding to marketplace server 150 or retrieve other server information for an online lending marketplace hosted by marketplace server 150, as discussed herein. Browser module 140 may receive a lending marketplace interface for use of the online lending marketplace by user 104. The lending marketplace interface may allow for user 104 to search, negotiate, accept, and/or repay one or more financial offers (e.g., an offer of a loan, credit, and/or refinancing) offered by a lending user (e.g., user 102), which may utilize one or more other lenders, in various embodiments. In various embodiments, browser module 140 may include a general browser application configures to retrieve, present, and communication information over the Internet (e.g., utilize resource on the World Wide Web) or a private network. However, in other embodiments, browser module 140 may include a dedicated application of marketplace module 150 or other entity, which may be configured to send and receive data over the Internet or private network using one or more application interfaces (e.g., interfaces specifically designed for the application and displayable using the application software).

Thus, browser module 140 may display the lending marketplace interface to user 104 through one or more output displays of communication device 130, which may include visual, audio, and/or audiovisual displays. User 104 may utilize the lending marketplace interface to communicate information to marketplace server 150 to search for one or more financial offers meeting the requirements, interests, and/or set terms and information by user 104. Such information used in a search may include an amount for the financial offer, an interest rate and origination, closing, or maintenance fees of the financial offer, a repayment structure of the financial offer, required collateral for disbursement of the financial offer (including acceptance of real of virtual assets, a value to the collateral, and a value to various virtual assets to user 102 and/or user 104). In various embodiments, a risk score for user 104 may be communicated to marketplace server 150, for example, from database 136. The risk score may be particular to user 104 with the online lending marketplace and/or may include other risk assessments, such as a transaction history, credit score, etc. The risk score for a new user may be determined using a credit score from a credit agency or other available information. However, the risk score may also vary and adjust as user 104 accepts financial offers and provides, completes, and/or is delinquent in repayment of the financial offer. The risk score may also include multiple scores, such as an internal score for using the online lending marketplace, and external scores, for example, credit scores for credit agencies, etc. In other embodiments, marketplace server 150 may include and/or retrieve such information during a search or subsequent attempt for negotiation/acceptance.

The information may further include payment and/or account information allowing for acceptance of the amount of the financial offer and disbursement of the amount of the financial offer. Once the information is communicated to marketplace server 150, user 102 may be receive one or more financial offers from the online lending marketplace. User 104 may browse the financial offer(s) and accept the financial offer, negotiate the financial offer, or decline the financial offer. If user 104 declines the financial offer, a new financial offer may be provided to user 104 based on the search terms. However, if user 104 negotiates the financial offer, negotiable terms may be entered into the lending marketplace interface by user 104 and communicated to user 102 and/or other lending users through the online lending marketplace. In such a manner, user 104 may conduct asynchronous negotiations with user 102. In various embodiments, the lending marketplace interface may provide for direct communication, using phone, online messaging, or other communication protocol to conduct synchronized negotiation. Negotiation may adjust one or more terms of the financial offer. Browser module 140 may display notifications through the lending marketplace interface related to negotiation and/or acceptance of terms by the lender(s) (e.g., user 102). The notifications may allow for user 104 to negotiate the financial offer with user 102.

Once the financial offer is acceptable to user 104, user 104 may accept the financial offer using browser module 140 through the lending marketplace interface. The lending marketplace interface may then provide for contractual acceptance of the financial offer. Any loan fees at the initial time of the loan may be paid by user 104 through browser module 140 or may be deducted from the initial loan amount. Moreover, the lending marketplace interface displayed through browser module 140 may further require submission of collateral according to terms of the financial agreement. Where the collateral corresponds to a virtual asset, user 104 may provide the virtual asset (e.g., video game item/currency), access to the virtual asset, and/or login information or control information for the virtual asset to marketplace server 150. Marketplace server 150 may hold the virtual asset for later release to user 102 on default or user 104 on completion of repayment. The lending marketplace interface may also be utilized to review repayment and remove control or possession over collateral by user 104 in the event of default. However, in other embodiments, user 104 may receive notifications and engage in negotiation, review disbursement and repayment, and collect collateral in the event of default using another application, including a messaging application.

Wallet module 132 may correspond to one or more processes to execute modules and associated specialized hardware of communication device 130 to receive payment for an amount of a financial offer to marketplace server 150. In this regard, wallet module 132 may correspond to specialized hardware and/or software utilized to provide a convenient interface to permit user 104 to select disbursement options and receive payment for the amount of the financial offer from marketplace server 150, for example, to a banking account, payment service provider account (e.g., provided by PAYPAY®, VENMO®, or other payment service provider), virtual account (including gaming accounts), or through physical means, such as cash payout and mailed check. For example, wallet module 132 may be implemented as a user interface enabling user 102 to enter disbursement options for storage by communication device 130, provide those options on completion of a financial offer or acceptance of the financial offer, and receive a payment of an amount from marketplace server 150. In some embodiments, wallet module 132 may correspond more generally to a web browser (e.g., browser module 140) configured to view information available over the Internet or access a website corresponding to a payment service provider. In various embodiments, wallet module 132 may further be utilized to provide repayment amounts to user 102 (e.g., through communication device 110) and/or marketplace server 150 during repayment of a financial offer. Thus, wallet module 132 may utilize user financial information, such as a credit card, bank account, or other financial account, as a payment instrument when providing payment information for repayment. Additionally, wallet module 132 may utilize a user account with payment provider for payment.

In various embodiments, one or more features of browser module 140 and/or wallet module 132 may be incorporated in the same application so as to provide their respective features in one application.

Communication device 130 includes other applications 134 as may be desired in particular embodiments to provide features to communication device 130. For example, other applications 134 may include security applications for implementing client-side security features, programmatic client applications for interfacing with appropriate application programming interfaces (APIs) over a network, or other types of applications. Other applications 134 may also include email, texting, voice and IM applications that allow a user to send and receive emails, calls, texts, and other notifications through a network, including notifications related to a financial offer (e.g., negotiable terms, acceptance of a negotiation, disbursement of an amount, repayment, and/or default). In various embodiments, other applications 134 may include financial applications, such as banking, online payments, money transfer, or other applications associated with a payment provider. Other applications 134 may include social networking, media sharing, banking, video game, and other applications, which may also be used in conjunction with wallet module 132 and/or browser module 140, for example, to access and/or provide virtual assets as collateral required for a financial offer. Other applications 134 may contain software programs, executable by a processor, including a graphical user interface (GUI) configured to provide an interface to the user.

Communication device 130 may further include database 136 which may include, for example, identifiers such as operating system registry entries, cookies associated with browser module 140, wallet module 132, and/or other applications 134, identifiers associated with hardware of communication device 130, or other appropriate identifiers, such as identifiers used for payment/user/device authentication or identification. Identifiers in database 136 may be used by marketplace server 150 to associate communication device 130 with a particular account maintained by marketplace server 150. Database 136 may include communication device tokens and/or encryption keys, including key(s) for marketplace server 150. Database 136 may include received and communicated information, which may be utilized to search for a financial offer, negotiate terms of a financial offer, accept a financial offer, provide repayment of a repayment amount of the financial offer, and/or provide collateral in the event of default by user 104.

Communication device 130 includes at least one communication module 138 adapted to communicate with communication device 110 and/or marketplace server 150. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Marketplace server 150 may be maintained, for example, by a service provider entity, which may provide notification services to merchants, as well as towns, cities, municipalities, counties, states, governmental agencies, land or location owners, or other entities. In this regard, marketplace server 150 includes one or more processing applications which may be configured to interact with communication device 110 and/or marketplace server 150 to provide an online lending marketplace for one or more financial offers. In one example, marketplace server 150 may be provided by EBAY®, Inc. of San Jose, Calif., USA and/or PAYPAL®, Inc. of San Jose, Calif., USA. However, in other embodiments, marketplace server 150 may be maintained by or include another marketplace and/or service provider, which may provide the online lending marketplace to user 102 and user 104, as well as other lenders and borrowers.

Marketplace server 150 of FIG. 1 includes a lending marketplace module 160, a payment and loan module 152, other applications 154, a database 156, and a network interface component 158. Lending marketplace module 160, payment and loan module 152, and other applications 154 may correspond to executable processes, procedures, and/or applications with associated hardware. In other embodiments, marketplace server 150 may include additional or different modules having specialized hardware and/or software as required.

Lending marketplace module 160 may correspond to one or more processes to execute modules and associated specialized hardware of marketplace server 150 to provide an online lending marketplace where one or more lenders (e.g., user 102) may generate financial offers extendable to borrowers (e.g., user 104), engage in negotiation of the financial offer between lenders and borrowers, process acceptance and disbursement of a financial offer, complete repayment for the financial offer by a borrower, and/or release collateral to a borrower on repayment or a lender on default. In this regard, lending marketplace module 160 may correspond to specialized hardware and/or software to provide a lending marketplace interface for the online lending, which may accessible over network 170. The online marketplace may be accessible through a web browser and thus correspond to a website, or may be accessible using a dedicated application for marketplace server 150. Lending marketplace module 160 may communicate the lending marketplace interface to communication device 110/130 over network 170, or the dedicated application may include a template interface having fillable elements using data received from marketplace module 160. Lending marketplace module 160 may facilitate establishment of a financial offer using information provided by user 102, as discussed herein. Moreover, lending marketplace module 160 may also facilitate finding of co-lenders with user 102 for a financial offer, such that user 102 may contribute part of the amount for the financial offer and post the financial offer for one or more other co-lenders to contribute the rest of the amount and become co-lenders for the financial offer. Once established, lending marketplace module 160 may post the financial offers, for example, to a browseable and/or searchable database, webpage listing, or other information source. Lending marketplace module 160 may also require payment for the amount of the financial offer, which may be completed using payment and loan module 152, as discussed herein.

Thus, user 104 may access the online lending marketplace using the lending marketplace interface, as discussed herein. Lending marketplace module 160 may receive one or more search terms, interests, or other information from user 104. Lending marketplace module 160 may search the financial offers, for example, in database 156 to determine one or more offers to present to user 104 on communication device 130. User 104 may decline a financial offer, whereby lending marketplace module 160 may perform another search using the search terms. In various embodiments, lending marketplace module 160 may display multiple financial offers on webpage or multiple webpages, so that users may browse the financial offers and select one or more of the financial offers. The financial offer may also vary within lending marketplace module 160 based on credit ratings and/or repayment scores for a borrower (e.g., user 104). For example, a financial offer established by user 102 may offer 5% interest for high credit scores (e.g., over or at a threshold rating/number) and a 10% interest for low credit scores (e.g., not meeting the set limit) Thus, user 104 may view different terms for a financial offer by user 102 than other users depending on each users' respective credit scores and/or repayment scores. Lending marketplace module 160 may also be utilized to negotiate a financial transaction between user 102 and 104, for example, by providing a negotiation interface and/or messaging where user 102 and user 104 are able to propose one or more terms and adjust such terms. Thus, lending marketplace module 160 may be utilized to provide communications between user 102 and user 104.

After the terms of the financial offer are acceptable to both user 102 and user 104, lending marketplace module 160 may process an acceptance of the financial offer by user 104 where user 104 accepts the terms of the offer presented by user 102 and accepts disbursement and payment of an amount of the offer. In this regard, lending marketplace module 160 may be used to communicate contractual terms to user 104 used to complete a contract for the financial offer by user 102 to user 104. User 104 may be required to sign or electronically sign (including click acceptance at the end of an agreement, entry of personal information, and/or electronic signature through an input device) the contract for the financial offer. After user 104 has completed the contract, payment and loan module may be utilized to disburse an amount to user 104 as well as receive and process repayments, as discussed herein.

In various embodiments, collateral may be provided to marketplace server 150 for a financial offer between user 102 and user 104, which may include virtual assets. A virtual asset may include a social networking account, a media sharing account, a messaging account, an email account, an online banking account, a video game account, a video game currency, and/or a video game item or obtainable asset. In various embodiments, the required virtual asset as collateral may be set by user 102 with marketplace server 150, or may be negotiated between user 102 and user 104 (e.g., an acceptance of a bank account login as a virtual collateral asset by user 102 and user 104). In other embodiments, user 102 may set a requested amount as collateral, such as $1000 dollars or other value or currency (including virtual values and currencies, such as webpage hits, social networking friends/followers, video game asset or currency, etc.). Thus, user 104 may provide one or more virtual assets meeting the associated collateral amount. Where user 102 requests a collateral amount, lending marketplace module 160 may determine a value of a proffered virtual asset by user 104, for example, based on a general value of the virtual asset (e.g., a set amount for a social media account, video game profile, etc.). Lending marketplace module 160 may also determine the value of the virtual asset based on the information and parameters of the virtual asset, such as income streams, advertisement revenue, in-game or real work video game asset value. Thus, a social networking (e.g., FACEBOOK®) or media sharing (e.g., YOUTUBE®) account having many followers may be of more value than a social networking or media sharing account having few followers (e.g., based on expected advertisement revenue on page visits or views). Moreover, user 104 may set a value of the virtual asset, such as a high value to a social networking often used by user 104, User 102 may choose to accept the value set by user 104 or may negotiate the value with user 104 using lending marketplace module 160. Thus, lending marketplace module 160 may be utilized to valuate collateral provided to lending marketplace module 160, including virtual assets.

For example, lending marketplace module may determine a value of a virtual asset (e.g., account access to Facebook or Yelp, posting ability, viewing ability, etc.) for a borrower since the virtual asset may have little or no value to the lender(s), and the lender's primary reason for the collateral is to increase the chances that the borrower will repay the loan and thus get the virtual asset back. Therefore, an amount of access by the borrower to the virtual asset and/or a type of access to an account may have varying value to borrower, such that the lender can determine right level for the loan amount. The value may be higher based on a status and/or if a user is close to achieving some status on with a virtual asset (e.g., due to hitting a number of posted reviews). Thus, if the borrower is prevented access, the borrower may incur a financial or other type of damage or value loss or non-gain such that the borrower may wish to retain access to the virtual asset. The lender may also allow part of the virtual assets back based on partial repayments (e.g., viewing access, limited posting access, etc.). An administrator using marketplace server 150 may also valuate the virtual asset as an impartial third party. The collateral may be a combination of virtual and real assets. Therefore, rates or other terms may be higher or less favorable with virtual asset collateral. Default or late payment may result in the lender being able to post from the borrower's account (including a negative remark, etc.). Moreover, in order to prevent the borrower from establishing another account and/or accessing the account using the login, a collateral key may be required for use of the virtual asset by the user and/or for use of the service providing the virtual asset using the user's identification (e.g., personal information, IP address, financial information, etc.). The collateral key may be required to establish an account or other virtual asset with the user's identification. Moreover, the collateral key may be required during login, so that the collateral key can be withheld in the event of default so that the borrower cannot access/use the collateral asset. The service provider may establish the collateral key in an interface for login to the virtual asset or for use of the virtual asset.

Payment and loan module 152 may correspond to one or more processes to execute modules and associated specialized hardware of marketplace server 150 to receive and/or transmit information from communication device 110 and/or communication device 130 for use in providing payments for disbursement of a financial offer and/or receiving repayments for repayment of said financial offer. In this regard, payment and loan module 152 may correspond to specialized hardware and/or software to process received payment information from user 102 through communication device 110 for an amount available to a borrower (e.g., user 104) in a financial offer established by user 102 and/or other lenders. Thus, user 102 may provide a payment instrument, including a bank account, payment card, payment account, or other transferrable asset to payment and loan module 152, which may process the payment instrument to receive the amount for the financial offer. Payment and loan module 152 may receive the amount for the payment instrument and hold the amount in escrow for acceptance of the financial offer. In such embodiments, payment and loan module 152 may provide the amount back to user 102 if the financial offer is not accepted or if user 102 chooses to remove the financial offer. In other embodiments, on acceptance of the financial offer, payment and loan module 152 may bill or process the payment instrument to receive the amount.

After acceptance of the financial offer by user 104, payment and loan module 152 may disburse the amount of the financial offer to user 104. Payment and loan module 152 may disburse the amount by providing the amount to the user, for example, in a bank account, payment account, or payment provider service (e.g. PAYPAL® or VENMO®). In other embodiments, payment and loan module 152 may cause one or more other financial service providers to provide the amount to user 104, such as through a check, cash payout, or other payment means. Payment and loan module 152 may further be used to provide repayment to user 102 from user 104. In this regard, payment and loan module 152 may receive a payment instrument from user 104 and process the payment instrument to provide payment to user 102.

In various embodiments, marketplace server 150 includes other applications 154 as may be desired in particular embodiments to provide features to marketplace server 150. For example, other applications 154 may include security applications for implementing client-side security features, programmatic client applications for interfacing with appropriate application programming interfaces (APIs) over network 160, or other types of applications. Other applications 154 may contain software programs, executable by a processor, including a graphical user interface (GUI), configured to provide an interface to user 102 and/or 104 when accessing marketplace server 150, such as a website interface. In various embodiments where not provided by lending marketplace module 160, other applications 154 may include connection and/or communication applications, which may be utilized to communication information to over network 170.

Additionally, marketplace server 150 includes database 156. Database 156 may be utilized to store information utilized by one or more modules and/or applications of marketplace server 150, including lending marketplace module 160, payment and loan module 152, and/or other applications 154. In this regard, database 156 may include received and/or determined information, including financial offers and negotiations.

In various embodiments, marketplace server 150 includes at least one network interface component 158 adapted to communicate communication device 110 and/or communication device 130 over network 170. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

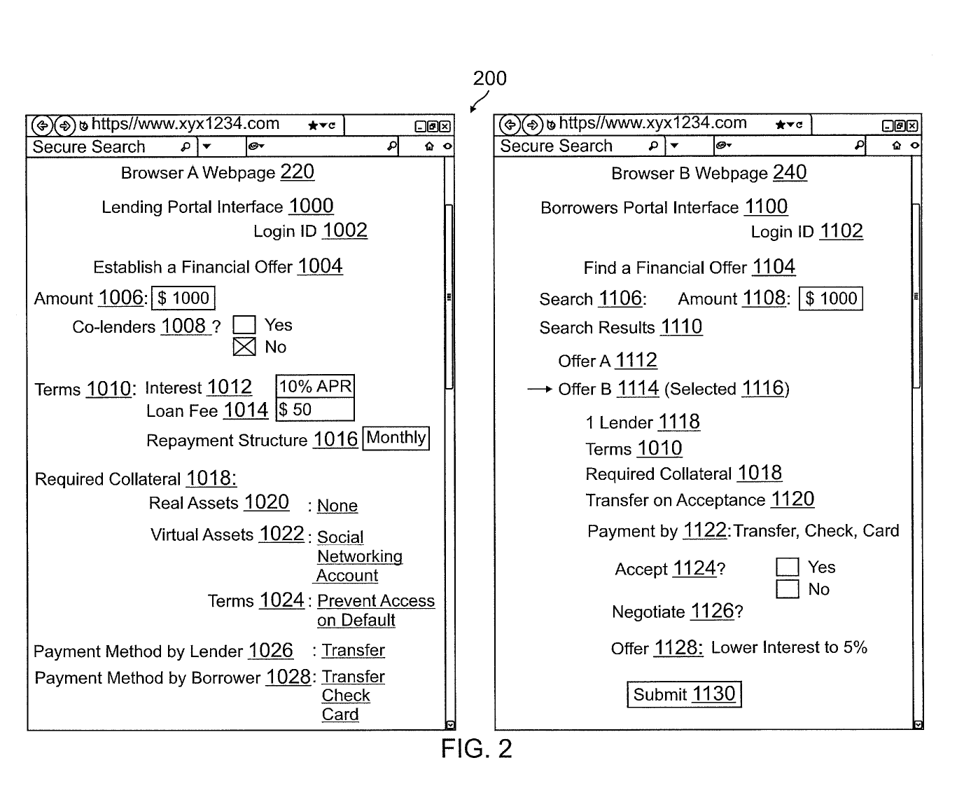

FIG. 2 shows two exemplary browser webpages having borrower and lender interfaces for an online lending marketplace, according to an embodiment. Environment 200 of FIG. 2 includes a browser A webpage 220 and a browser B webpage 240 corresponding generally to the described modules, hardware, and processes described in reference to browser module 120 and browser module 140, respectively, of FIG. 1.

Browser A webpage 220 includes a lending portal interface 1000 that may be utilized by a lender viewing browser A webpage 220 to establish a financial offer for a borrower. In this regard, lending portal interface 1000 includes a login ID 1002 for the lender and an interface form to establish a financial offer 1004. The interface to establish a financial offer 1004 includes an amount 1006, terms 1010, required collateral 1018, a payment method by lender 1026 to provide an amount to a borrower, and a payment method by borrower 1028 to provide repayment of the amount. Amount 1006 includes a box having $1000 as the amount to be provided to a borrower that accepts the financial offer. The lender utilizing lending portal interface 1000 may also choose to have co-lenders 1008, where the initial lender has selected not to have co-lenders. However, in other embodiments, the lender may choose to have co-lenders, where all the co-lenders set the amount the co-lenders may contribute and negotiate their repayment structures, amounts, and/or interest rates.

Terms 1010 includes interest 1012 that the lender sets as the interest on the financial offer. Interest 1012 includes 10% APR, but may also include shorter or longer terms, as well as fixed and/or variable rates. Terms 1010 includes a loan fee 1014, which may be a fee for accepting the financial offer or on completion of repayment of the financial offer. Terms 1010 also includes a repayment structure 1016, which includes monthly, but may also correspond to other repayment terms (e.g., weekly, yearly, etc.) as well as a required installment payment per each term.

The lender may further establish required collateral 1018. One type of collateral may be real assets 1020, which may include vehicles, land, housing, jewelry, furniture, or other types of real property. However, required collateral 1018 may also include virtual assets, which may be intangible assets, including online and other types of virtual property. The lender may accept virtual assets 1022 as collateral and may set the required virtual asset as a social networking account in environment 200. The lender may further specify what happens on default under terms 1024, where the lender has chosen to prevent access to virtual assets 1022 on default. The lender may further specify a payment method by lender 1026 to disburse the payment, which the lender has noted as transfer. Moreover, under payment method by borrower 1028, the lender may accept repayment through transfer, check, and/or card. Using the aforementioned information, an online lending marketplace may generate and post a financial offer available to borrowers.

Browser B webpage 240 includes a borrower's portal interface 1100 that may be utilized by a lender viewing browser B webpage 240 to search for a financial offer of interest to a borrower. In this regard, borrower's portal interface 1100 includes a login ID to log in and verify the identity of the borrower. Moreover, borrower's portal interface includes an interface form to find a financial offer 1104. The interface form to find a financial offer 1104 includes a search 1106 field and search results 1110. Search 1106 includes an amount 1108 of $100, however, search 1106 may include more or different field and search terms, in various embodiments. Search results 1110 includes an offer A 1112 and an offer B 1114, where offer B 1114 corresponds to the financial offer established by the lender of browser A webpage 220. Thus, offer B 1114 shows various fields after highlighting with selected 1116.

Offer B 1114 includes information utilized by the borrower to determine whether the borrower would like to accept offer B 1114. Thus, offer B 1114 includes information for 1 lender 1118, terms 1010, required collateral 1018, transfer on acceptance 1120, and payment by transfer, check, or card 1122 all corresponding to information entered to lending portal interface 1000. Borrower's portal interface may further allow the borrower to accept 1124 through selection of one or more boxes, which may cause initiation of contractual agreements. Moreover, the borrower is given the option to negotiate 1126, such as with an offer 1128 requesting that the interest rate is lowered to 5%. The borrower may move forward with an action through selection of the submit 1130 option.

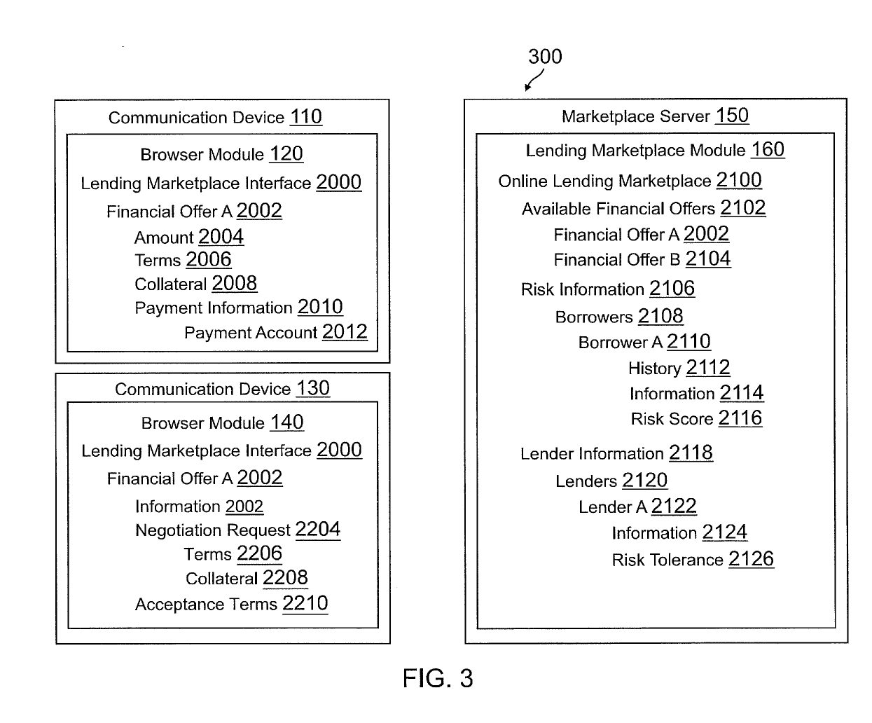

FIG. 3 is an exemplary system environment having communication devices executing browser modules for a lending marketplace interface and a server executing a lending marketplace module to provide one or more financial offers from a lender to a borrower, according to an embodiment. Environment 300 includes communication device 110, communication device 130, and marketplace server 150 of FIG. 1. The below described hardware and/or software modules execute functions as described herein with respect to environment 100.

Communication device 110 executes browser module 120 having specialized hardware and/or software modules and processes described herein in reference to FIG. 1. In this regard, browser module 120 includes information for use with a lending marketplace interface 2000. Browser module 120 is shown including information used with and displayed through lending marketplace interface 2000, for example, a financial offer A 2002. Financial offer A 2002 includes an amount 2004, terms 2006, collateral 2008, and payment information 2010, which may include a payment account 2012 for the lending user of communication device 110. Financial offer A 2002 may correspond to information input by the lending user for use in generating a financial offer of a loan, credit, financing, or refinancing offer. Thus, information for financial offer A 2002 may be communicated to marketplace server 150 for processing.

Marketplace server 150 executes lending marketplace module 160 having specialized hardware and/or software modules and processes described herein in reference to FIG. 1, Lending marketplace module 160 includes an online lending marketplace 2100, which may post one or more financial offers to online lending marketplace 2100, for example, financial offer A 2002. Online lending marketplace 2100 therefore includes available financial offers 2102, having financial offer A 2002 and financial offer B 2104. Online lending marketplace 2100 may also determine and store risk information 2106 based on repayment histories and/or other information (e.g., collateral asserts, credit history, etc.) of one or more borrowers. Risk information 2106 includes borrowers 2108, which may include borrower A 2110 (e.g., the borrowing user corresponding to communication device 130). Borrower A 2110's risk information may include a history 2112, information 2114 (e.g., personal and/or financial information for the borrower), and a risk score 2116. In order to prevent abuse of a risk assessment in risk score 2116, lending marketplace module 160 may utilize information 2114 with information 2124 to determine whether the lending user and the borrowing user have a prior relationship. If a prior relationship is found, lending marketplace module 160 may flag transactions and/or financial offers between the two for abuse and/or fraud. Similarly, online lending marketplace 2100 may include lender information 2118, which may be utilized in determination of a financial offer. Lender information 2118 includes lenders 2120, which may have lender A 2122 (e.g., the lending user corresponding to communication device 110). Lender A 2122 includes information 2124 (e.g., personal/financial information) and risk tolerance 2126.

Communication device 130 executes browser module 140 having specialized hardware and/or software modules and processes described herein in reference to FIG. 1. In this regard, browser module 140 includes information utilized with lending marketplace interface 2000. Lending marketplace interface 2000 may also be utilized to search for financial offers, including financial offer A 2002 shown in browser module 140. Financial offer A 2002 in browser module 140 may include information 2202, which may have information elements from input to browser module 120 (e.g., amount 2004, terms 2006, collateral 2008, and/or other determined information by marketplace server 150). Browser module 140 may also include a negotiation request 2204 for financial offer A 2002, which may have terms 2206 and collateral 2208 for negotiation with the lending user. Moreover, the borrowing user may view acceptance terms 2210 for financial offer A 2002, which may include a contract or other agreement for entering into financial offer A 2002.

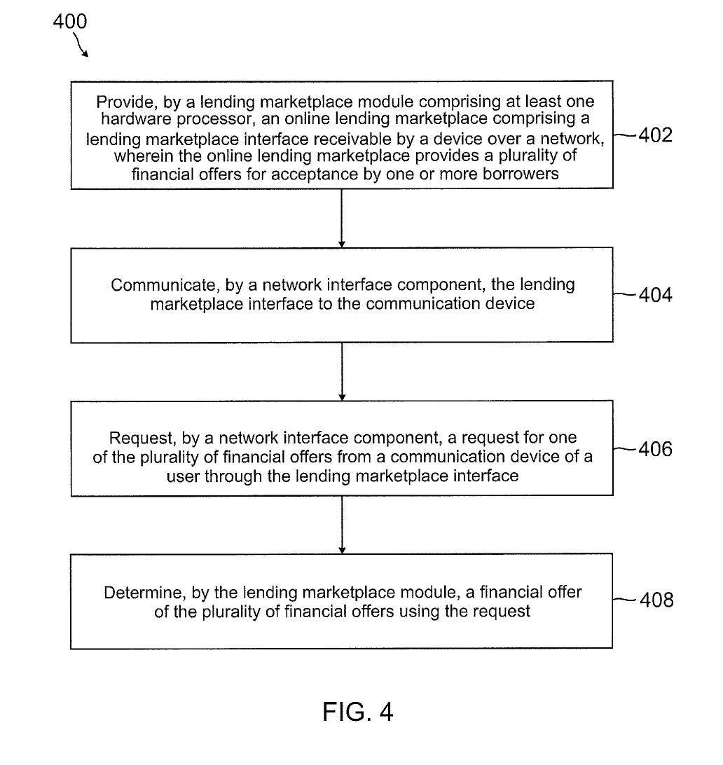

FIG. 4 is a flowchart of an exemplary process for an online marketplace interface having a network of qualified user offers, according to an embodiment. Note that one or more steps, processes, and methods described herein may be omitted, performed in a different sequence, or combined as desired or appropriate.

At step 402, an online lending marketplace comprising a lending marketplace interface receivable by a communication device over a network is provided, by a lending marketplace module comprising at least one hardware processor, wherein the online lending marketplace provides a plurality of financial offers for acceptance by one or more borrowers. The lending marketplace interface may be receivable by a communication device of a borrowing user and/or a communication device of a lending user. Thus, at step 404, the lending marketplace interface is communicated, by the network interface component, to the communication device. In various embodiments, the lending user may correspond to one or a plurality of lending users, wherein the lending user(s) generate at least one of the plurality of financial offers. For example, the lending user(s) may establish a first financial offer by providing a financial instrument and financial value for the first financial offer to the lending marketplace module through the lending marketplace interface, wherein the lending marketplace module determines the first financial offer using the financial instrument and the financial value and posts the first financial offer to the online lending marketplace for viewing using the lending marketplace interface by a plurality of borrowing users. Where the lending users are a plurality of lending users, the plurality of lending users may each provide a certain amount, wherein fees to borrow for loan depend on a split fee agreement negotiated by the plurality of lending users using the lending marketplace interface.

A request for one of the plurality of financial offers is received, by the network interface component, from a communication device of a borrowing user through the lending marketplace interface, at step 406. Thus, a financial offer of the plurality of financial offers is determined, by the lending marketplace module, using the request, at step 408, The financial offer may be one of a credit offer, a loan offer, and a refinancing offer. The lending provider may set at least one term for acceptance of the first financial offer by the borrowing user and disbursement of an amount for the first financial offer to the borrowing user. The at least one term may comprise an interest on a repayment amount for the first financial offer, a fee for the acceptance and the disbursement, a repayment structure for the repayment amount, require collateral for the acceptance and the disbursement, and a payment method of the amount to the borrowing user. The borrowing user may be required to accept the at least one term to complete the acceptance and the disbursement for the financial offer. A payment and loan module comprising at least one hardware processor may process a transaction to provide the amount to the borrowing user if the user accepts the at least one term. The lending marketplace module may further determine a second financial offer of the plurality of financial offers using the first request if the use declines the at least one term.

At least one requirement in the at least one term may be variable based on an acceptable risk tolerance by the lending user and a risk score of the borrowing user. The risk score may be based on a history for the borrowing lender of repayments for at least one other financial offer from the online financial marketplace. The lending user may be hidden from the borrowing user in the first financial offer. Moreover, the lending marketplace module may determine whether the lending user and the borrowing user have a prior relationship and the lending marketplace module may flag the lending user and the borrowing user in the first financial transaction for review by an administrator if the lending user and the borrowing user have the prior relationship.

In various embodiments, the financial offer may require collateral for acceptance of the financial offer. For example, the financial offer may request at least a virtual asset as the collateral. The collateral may comprise a set value by a lending user, wherein a value of the virtual asset to meet the set value is dynamic based on at least one of an amount of use by the borrowing user, an importance to the borrowing user, a social value to the borrowing user, and a financial value to the borrowing user. The social and/or financial value may also depend on a value set or determined by the lending user. The virtual asset may comprise one of a social networking account, a media sharing account, a messaging account, an email account, an online banking account, a video game account, a video game currency, and a video game item or obtainable asset. The lending user may receive login details for the virtual asset on acceptance of the financial offer by the borrowing user.

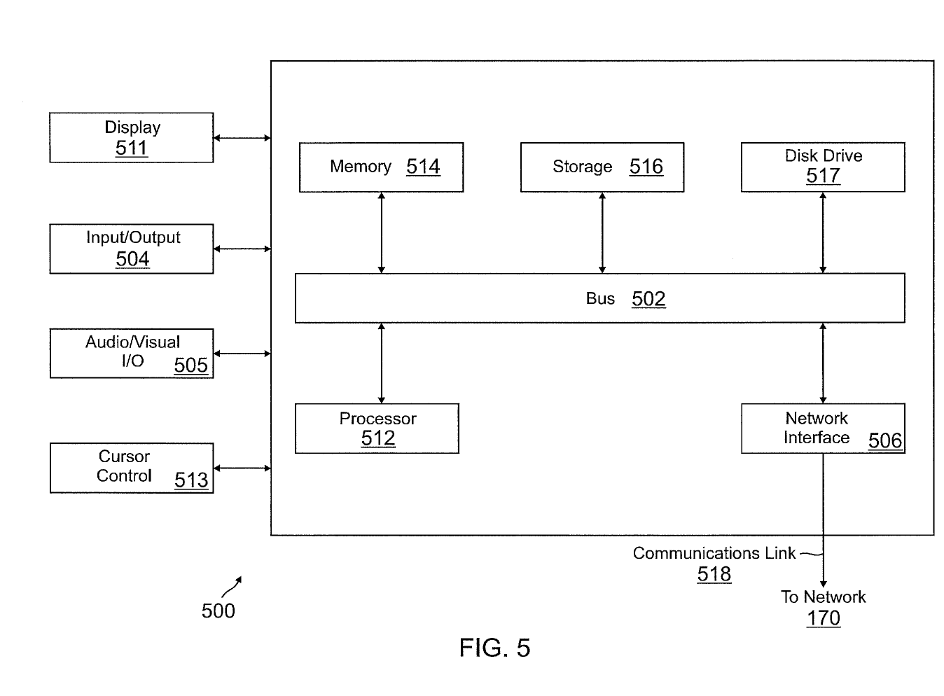

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via a network. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a lending marketplace module comprising at least one hardware processor that hosts an online lending marketplace comprising a lending marketplace interface receivable by a device over a network, wherein the online lending marketplace provides a plurality of financial offers for acceptance by one or more borrowers using a virtual asset of the one or more borrowers as collateral to the financial offer, accesses a request for one of the plurality of financial offers received from a first communication device of a borrowing user through the lending marketplace interface, and determines a first financial offer of the plurality of financial offers using the request;
a database stored to a non-transitory memory that stores the online lending marketplace, the plurality of financial offers, and the request; and
a network interface component that communicates the lending marketplace interface to the first communication device, receives the request from the first communication device, and communicates the first financial offer to the first communication device for display to the borrowing user.

2. The system of claim 1, wherein the first financial offer comprises one of a credit offer, a loan offer, and a refinancing offer.

3. The system of claim 1, wherein the network interface component further communicates the lending marketplace interface to a second communication device of at least one lending user, and wherein the at least one lending user generates at least one of the plurality of financial offers.

4. The system of claim 3, wherein the at least one lending user establishes the first financial offer by providing a financial instrument and financial value for the first financial offer to the lending marketplace module through the lending marketplace interface, and wherein the lending marketplace module determines the first financial offer using the financial instrument and the financial value and posts the first financial offer to the online lending marketplace for viewing using the lending marketplace interface by a plurality of borrowing users including the borrowing user.

5. The system of claim 4, wherein at least one lending user is a plurality of lending users, each providing a certain amount, and wherein fees to borrow for loan depend on a split fee agreement negotiated by the plurality of lending users using the lending marketplace interface.

6. The system of claim 4, wherein the at least one lending provider sets at least one term for acceptance of the first financial offer by the borrowing user and disbursement of an amount for the first financial offer to the borrowing user.

7. The system of claim 6, wherein the at least one term comprises an interest on a repayment amount for the first financial offer, a fee for the acceptance and the disbursement, a repayment structure for the repayment amount, require collateral for the acceptance and the disbursement, and a payment method of the amount to the borrowing user.

8. The system of claim 6, wherein the borrowing user is required to accept the at least one term to complete the acceptance and the disbursement.

9. The system of claim 8, further comprising a payment and loan module comprising at least one hardware processor that processes a transaction to provide the amount to the borrowing user if the user accepts the at least one term.

10. The system of claim 8, wherein the lending marketplace module further determines a second financial offer of the plurality of financial offers using the first request if the use declines the at least one term.

11. The system of claim 6, wherein at least one requirement in the at least one term is variable based on an acceptable risk tolerance by the lending user and a risk score of the borrowing user.

12. The system of claim 11, wherein the risk score is based on a history for the borrowing lender of repayments for at least one other financial offer from the online financial marketplace.

13. The system of claim 4, wherein the lending user is hidden from the borrowing user in the first financial offer.

14. The system of claim 1, wherein the lending marketplace module determines whether the lending user and the borrowing user have a prior relationship, and wherein the lending marketplace module flags the lending user and the borrowing user in the first financial transaction for review by an administrator if the lending user and the borrowing user have the prior relationship.

15. A method comprising:
providing, by a lending marketplace module comprising at least one hardware processor, an online lending marketplace comprising a lending marketplace interface receivable by a device over a network, wherein the online lending marketplace provides a plurality of financial offers for acceptance by one or more borrowers using a virtual asset of the one or more borrowers as collateral to the financial offer;
communicating, by a network interface component, the lending marketplace interface to the communication device;
receiving, by the network interface component, a request for one of the plurality of financial offers from a communication device of a borrowing user through the lending marketplace interface; and
determining, by the lending marketplace module, a financial offer of the plurality of financial offers using the request; and
communicating, by the network interface component, the financial offer to the communication device for display to the borrowing user.

16. The method of claim 15, wherein the financial offer requires collateral for acceptance of the financial offer, and wherein the financial offer requests the virtual asset as the collateral.

17. The method of claim 16, wherein the collateral comprises a set value by a lending user, and wherein a value of the virtual asset to meet the set value is dynamic based on at least one of an amount of use by the borrowing user, an importance to the borrowing user, a social value to the borrowing user, and a financial value to the borrowing user.

18. The method of claim 17, wherein the virtual asset comprises one of a social networking account, a media sharing account, a messaging account, an email account, an online banking account, a video game account, a video game currency, and a video game item or obtainable asset.

19. The method of claim 17, wherein the lending user receives login details for the virtual asset on acceptance of the financial offer by the borrowing user.

20. A non-transitory computer-readable medium comprising executable modules which, in response to execution by a computer system, cause the computer system to perform a method comprising:
providing, by a lending marketplace module comprising at least one hardware processor, an online lending marketplace comprising a lending marketplace interface receivable by a device over a network, wherein the online lending marketplace provides a plurality of financial offers for acceptance by one or more borrowers using a virtual asset of the one or more borrowers as collateral to the financial offer;
communicating, by a network interface component, the lending marketplace interface to the communication device;
receiving, by the network interface component, a request for one of the plurality of financial offers from a communication device of a user through the lending marketplace interface; and
determining, by the lending marketplace module, a financial offer of the plurality of financial offers using the request; and
communicating, by the network interface component, the financial offer to the communication device for display to the user.
